(19) United States
(12) Patent Application Publication
(10) Pub. No.: US 2024/0324605 A1
(43) Pub. Date: Oct. 3, 2024

(54) ESSENTIAL OIL IMPREGNATED DEVICE AND METHODS OF USE THEREOF

(71) Applicant: PERTINENT ECO-SOLUTIONS, INC., Peachtree Corners, GA (US)

(72) Inventor: Scot HUBER, Peachtree Corners, GA (US)

(21) Appl. No.: 18/621,931

(22) Filed: Mar. 29, 2024

Related U.S. Application Data
(60) Provisional application No. 63/493,073, filed on Mar. 30, 2023.

(51) Int. Cl. A01N 65/28; A01N 25/08; A01N 31/02; A01N 31/16; A01N 65/22; A01P 7/04

(52) U.S. Cl. CPC A01N 65/28; A01N 25/08; A01N 31/02; A01N 31/16; A01N 65/22; A01P 7/04

(57) ABSTRACT

Described herein are devices and methods of use thereof for controlling populations of pests. Such devices include at least a body and a substrate. Substrates include essential-oil-impregnated substrates (e.g., a natural glue). An additional layer may also be joined to a surface of the body sandwiching the substrate between the body and additional layer. Such devices can be located within spaces where pests are common. Once placed, they can control populations of pests that tend to eat substrates.

### CROSS-REFERENCE TO RELATED APPLICATIONS

This invention claims priority to U.S. Provisional Application Ser. No. 63/493,073, filed on Mar. 30, 2023, which is incorporated herein by reference in its entirety.

### TECHNICAL FIELD OF THE INVENTION

This invention is generally related to biocide impregnated devices and methods of use thereof.

### BACKGROUND OF THE INVENTION

Chemical pesticides and parasiticides have a high toxicity profile and numerous side effects. Many of the pesticides have been associated with health and environmental issues. The numerous negative health effects that have been associated with chemical pesticides include dermatological, gastrointestinal, neurological, carcinogenic, respiratory, reproductive, and endocrine effects. Furthermore, high occupational, accidental, or intentional exposure to pesticides can result in hospitalization and death. (Nicolopoulou-Stamati, P., et al., Front. Public Health, 4: 148 2016). Residues of pesticides can be found in a great variety of everyday foods and beverages. Pesticides residues have also been detected in human breast milk samples, and there are concerns about prenatal exposure and health effects in children.

However, many individuals today use inherently toxic pesticides indoor with seventy-five percent of U.S. households using at least one indoor pesticide during the past year. (“Indoor Air Quality,” EPA). A main use of these toxic chemicals indoors is to rid households, animal production facilities, commercial kitchens, schools, libraries, businesses, and other areas having insects and other pests.

Therefore, because pesticides have a high toxicity but are frequently used indoors, there is a need to find alternatives.

### SUMMARY OF THE INVENTION

It is to be understood that this summary is not an extensive overview of the disclosure. This summary is an example and not restrictive and it is intended to neither identify key or critical elements of the disclosure nor delineate the scope thereof. The sole purpose of this summary is to explain and exemplify certain concepts of the disclosure as an introduction to the following complete and extensive detailed description.

The present disclosure relates to an essential-oil impregnated device for controlling pests. Such a device includes a body. The body can include a variety of materials including but not limited to cardboard, corrugated cardboard, paper, paper-derived materials, cellulosics, plastics, polymers, metals, and any material capable of retaining compositions described herein.

The present disclosure further relates to devices including a substrate. The substrate is impregnated with an essential oil and exposes the insect to the essential oil. The substrate may be, as non-limiting examples, a food for an insect, a bait, a material containing a chemical attractant, and the like. The substrate may further contain cavities, corridors, or other openings where an insect may harbor or be received; or a combination of these or other factors that allow the insect to be exposed to the essential oil. For instance, the substrate may be a glue on which the insect feeds. Such glues may be formed from, amongst other ingredients, water and flour. Suitable substrates can be combined with essential oils to form essential-oil-impregnated substrates to which the insect is attracted. Essential oils may be selected from geraniol, clove oil, thyme oil, eugenol, and any combinations thereof. The impregnated substrate may be applied to or placed in a body of the device.

The present disclosure further relates to additional layers which, in one embodiment, may include layers made from paper-based products. Such layers can be applied to or used to form bodies of the device that have been treated with an essential-oil-impregnated substrate. The invention contemplates, in one embodiment, adhering at least one additional layer to the container to form a device suitable for use according to the present disclosure.

The present disclosure also relates to methods of use of devices and compositions disclosed herein. Devices include, but are not limited to, a device body, at least one additional layer, at least one substrate, and one or more essential oils or blends thereof which are suitable for placement in an indoor location. Pests that tend to eat glues (e.g., glue found in crevices of cardboard) will eat the essential-oil-impregnated substrate of the device. This then controls the pests by killing, repelling, inhibiting, suppressing, or repressing populations of pests that ingest the substrate. A wide variety of pests may be controlled by devices and methods disclosed herein. As a non-limiting example, silverfish may be controlled.

### BRIEF DESCRIPTION OF THE DRAWINGS

FIG. 1 displays a top view of a surface of an embodiment according to aspects of the present disclosure.

FIG. 2 displays a top view of a surface of an embodiment opposing the surface displayed in FIG. 1 according to aspects of the present disclosure.

FIG. 3 displays a top view of a side surface of an embodiment according to aspects of the present disclosure.

### DETAILED DESCRIPTION OF THE INVENTION

### I. Definitions

It should be appreciated that this disclosure is not limited to the devices, compositions, and methods described herein as well as the experimental conditions described, as such may vary. It is also to be understood that the terminology used herein is for the purpose of describing certain embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. References to techniques employed herein are intended to refer to the techniques as commonly understood in the art, including variations on those techniques or substitutions of equivalent techniques that would be apparent to one skilled in the art. Although any devices, compositions, and methods similar or equivalent to those described herein can be used in the practice or testing of the present invention. All publications mentioned are incorporated herein by reference in their entirety.

In describing the presently disclosed subject matter, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The use of the terms “a,” “an,” “the,” and similar referents in the context of describing the presently claimed invention (especially in the context of the claims) are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein.

Use of the term “about” is intended to describe values either above or below the stated value in a range of approx. +/−10% by weight; in other embodiments the values may range in value either above or below the stated value in a range of approx. +/−5% by weight; in other embodiments the values may range in value either above or below the stated value in a range of approx. +/−2% by weight; in other embodiments the values may range in value either above or below the stated value in a range of approx. +/−1% by weight. The preceding ranges are intended to be made clear by context, and no further limitation is implied. All methods described herein can be performed in any suitable order unless otherwise indicated herein or otherwise clearly contradicted by context. The use of any and all examples, or example language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

As used herein, percentages relating to compositions and components thereof are given as weight percentages, unless otherwise specified. As a non-limiting example, a composition comprising 50% by weight essential oil would owe half of its weight to the essential oil in the composition.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

As used herein, the term “attractant” refers to any substance that attracts pests disclosed herein. As a non-limiting example, an attractant may be any glue including but not limited to flour-based glues.

As used herein, the term “biocide” refers to any composition disclosed herein used to kill, repel, or otherwise affect any number of pests. Biocides typically include at least one essential oil and pose significantly fewer health risks than traditional pesticides.

As used herein, the term “killing” refers to the act of causing the death of pests (e.g., arthropods, external parasites, and the like), wherein this act can occur as a result of administration of compositions described herein. In this manner, any composition resulting in killing can be described with the suffix “-cide”. It is to be understood that this act can be applied to any life cycle of a pest, including but not limited to the egg, larval, pupal, and adult life cycles of an insect.

As used herein, the terms “kill,” “repel”, “inhibit”, “suppress”, “repress”, “control”, and grammatical variants thereof are used interchangeably and refer to an activity whereby pest (e.g., arthropods, external parasites, and the like) activity and/or viability is reduced below that observed in the absence of a composition of the presently disclosed subject matter. In some embodiments, pest control that results in repels or inhibits results in a decrease in the presence and/or survivability of an arthropod or insect in an environment or on a subject. It is to be understood that the acts described above can be applied to any life cycle of a pest.

### II. Essential Oil Impregnated Compositions

The present disclosure relates to compositions for controlling pests. As non-limiting examples, controlling pests includes killing, repelling, resisting, inhibiting, repressing, or suppressing such pests. Compositions disclosed herein control pests through use of one or more compositions that are non-toxic to humans. Such compositions include one or more essential oils or blends thereof and may be referred to as biocides. Such essential oils or blends thereof may be combined with one or more substrates. In some examples, essential oils or blends thereof are disposed on top of substrates where the oils or blends thereof may absorb into the substrate to combine with the substrate. This creates an essential-oil-impregnated substrate. Additional components may also be added to compositions disclosed herein, as necessary and as further described below.

A blend of one or more essential oils can include any essential oil known or otherwise disclosed herein. Essential oils may repel pests, thus making it difficult to expose pests to the essential oils. The present disclosure relates to combining essential oils with additional substances in order to attract the pests to the essential oils that pests would otherwise avoid. This causes pests to come into contact with essential oils that can kill, weaken, or otherwise control the pests where pests would otherwise not come into contact with the repellant essential oils. As such, pests that consume essential-oil-impregnated substrates, as disclosed herein, are effectively controlled in a surprising manner.

As non-limiting examples, essential oils include but are not limited to geraniol, linalool, carvacrol, para-cymene, alpha-pinene, menthol, eugenol, carvacrol, citronella oil, citronellal, citronellol, cinnamaldehyde, cinnamol, mint oils including cornmint oil and peppermint oil, thyme oil, lemongrass oil, rosemary oil, oregano oil, clove oil, citronella oil, cedar oil, cinnamon oil, wintergreen oil, alpha-terpineol, camphor, carvacrol, delta-cadinene, e-beta-caryophyllene, e-sabinene, limonene, p-cymene-8-ol, cerpinen-4-ol, terpinolene, thymol vic-thymol, cedrol, 1,8-cineol,3-carene,3-octanol,3-octanone, 6-ethyl-3,4-dimethylphenol, alpha-humulene, alpha-phellandrene, alpha-pinene, alpha-terpinene, alpha-thujene, aromadendrene, beta-pinene, beta-terpinene, borneol, bornyl acetate, camphene, carvacrol methyl ether, carvone, R-carvone, caryophyllene oxide, citronellal, citronellol, citronellal, e-beta-ocimene, eugenol, gamma-terpinene, geranyl acetate, isoeugenol, ledene, lemongrass oil, limonene, Linalool, menthol, methyl isoeugenol, methyl salicylate, myrcene, nerol, nootkatone, ocimene, p-cymene, safrol, terpinene-4-ol, terpineol, thymol acetate, Z-beta-ocimene, Z-linalool oxide, and combinations and mixtures thereof.

Substrates include any material capable of being combined with one or more essential oils. Combination may include one or more essential oils at least partially absorbing into a substrate. Combinations may further be created by blending a substrate and one or more essential oils to create a suspension of oil and substrate, As non-limiting examples, substrates include but are not limited to a number of glues, baits, foods, sugars, chemical attractants, and any combinations thereof. In an example embodiment, the substrate is a glue or a combination of glues. Glues include but are not limited to natural-based and synthetic glues. As a non-limiting example, a natural-based glue may comprise a mixture of water and flour. Any flour can be used to create a natural-based glue including but not limited to wheat, rice, barley or other grain-based flours. Glues may also be made from animal materials such as hooves, skin, and other byproducts of animal processing. As a non-limiting example, flour and water may be combined in various amounts and ratios to form glues according to the present disclosure. In one such example, any combination of flour and water that is sufficient to create a slurry is appropriate, for example from 1 part up to 10 parts of water combined with 1 part of flour.

The present disclosure further relates to additional components to be added to compositions disclosed herein. Essential oils, substrates, and any combinations thereof can additionally be combined with a number of components including but not limited to emulsifiers, surfactants, lubricants, plasticizers, flow agents, antimicrobials, any combinations thereof, and any additional components that may aid processing or provide additional, desired qualities.

The present disclosure may relate to an emulsifier. An emulsifier, when utilized, may be selected from polyglyceryl oleate, polyglyceryl stearate, glyceryl monooleate, or other glyceryl esters; or other emulsifiers selected from classes such as lecithins, EO/PO block copolymers, polyoxyethylene sorbitan monolaurates, sorbitan monolaurates, polyoxyethylene ethers, ethoxylated esters, ethoxylated triglycerides, ethoxylated elcohols, ethoxylated amines, alkylphenol ethoxylates, or tristearylphenol ethoxylates, and any combinations thereof.

The present disclosure may relate to a surfactant. When utilized, a surfactant may include, for example, organosulfates or organosulfonates such as sodium lauryl sulfate or sodium laureth sulfate; soaps (C₆-C₂₀ fatty acid metal salts, such as sodium caprylate or potassium laurate, or the saponification products of long-chain fatty acids or fatty acid esters), or other detergents.

The present disclosure may relate to insect growth regulators (IGRs). IGRs may be used in combination with other compositions disclosed herein. The class of acaricides or insecticides known as IGRs are known in the art and represent a range of different chemical classes. IGR compounds may be included in the compositions of the invention to provide superior efficacy against, as an example, ectoparasites. Such IGRs are typically safe and do not affect humans. Such IGRs that are safe and do not affect humans may be included in compositions disclosed herein without compromising the non-toxic nature of the compositions described herein, including but not limited to essential-oil-impregnated substrates. These compounds all act by interfering with the development or growth of the insect pests. For example, some IGR compounds act by blocking the development of immature stages (eggs and larvae) into adult stages, or by inhibiting the synthesis of chitin. Some compounds in the IGR class mimic juvenile hormones. IGRs are described, for example, in U.S. Pat. Nos. 3,748,356; 3,818,047; 4,225,598; 4,798,837; 4,751,225, EP 0 179 022 or U.K. 2 140 010 as well as U.S. Pat. Nos. 6,096,329 and 6,685,954 (all incorporated herein by reference).

Non-limiting examples of IGRs suitable for use in compositions described in the present disclosure include, but are not limited to, azadirachtin, diofenolan, fenoxycarb, hydroprene, kinoprene, methoprene, pyriproxyfen, tetrahydroazadirachtin, 4-chloro-2-(2-chloro-2-methylpropyl)-5-(6-iodo-3-pyridylmethoxy)pyridizin-3-(2H)-one, cyromazine, chlorfluazuron, diflubenzuron, fluazuron, flucycloxuron, flufenoxuron, hexaflumuron, lufenuron, tebufenozide, teflubenzuron, triflumuron, novaluron, 1-(2, 6-difluorobenzoyl)-3-(2-fluoro-4-trifluoromethyl)phenylurea, 1-(2,6-difluorobenzoyl)-3-(2-fluoro-4-trifluoromethyl)phenylurea, 1-(2,6-difluorobenzoyl)-3-(2-fluoro-4-(1,1,2,2-tetrafluoroethoxy)phenylurea, 1-(2,6-difluorobenzoyl)-3-(2-fluoro-4-trifluoromethyl)phenylurea, and any combinations thereof. III. Essential-Oil Impregnated Devices

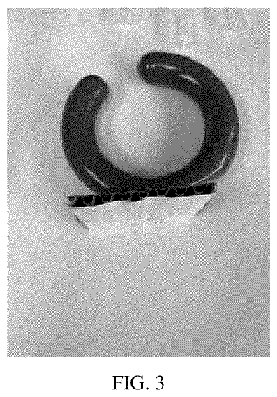

The present disclosure further relates to devices for controlling pests, as shown in FIGS. 1-3. Such devices include at least a body. Bodies include at least a first surface and an opposing surface. Such bodies include any body capable of retaining compositions described herein. As a non-limiting example, a body may include a variety of materials. The body can include a variety of materials including but not limited cardboard, corrugated cardboard, paper, paper-derived materials, cellulosics, plastics, polymers, metals, any material capable of retaining compositions described herein, and combinations thereof. In a particular, non-limiting example, a portion of cardboard or paper may be used. Such cardboard or paper may be corrugated. Corrugation allows an essential-oil-impregnated substrate to be received and retained in the folds of the corrugate. Corrugation also assists in coupling additional layers, as further discussed herein, to a body of a device. In such examples, pests, including but not limited to insects, tend to crawl inside corrugated materials to eat the glue found within cavities formed by the corrugated material. In another such example, pests may particularly prefer to crawl into crevices to consume glue.

The present disclosure relates to example devices including more than one body. In such an example, a first body may be couple to at least another body in a variety of configurations. Bodies may be coupled by being stapled, glued, taped, pressed, stacked, or joined together using any other coupling method known in the art. In an example configuration, multiple bodies may be stacked on top of one another. Once stacked, multiple bodies may be coupled to each other (e.g., as a non-limiting example, glued or stapled together). Stacked bodies may also be left uncoupled.

As an additional, non-limiting example, a configuration may include multiple bodies coupled to form one or more three-dimensional configurations. In such example, a first body may have at least one additional body coupled to it at an edge. In such an example, the at least one additional body may be oriented to extend perpendicularly from a surface of the first body. Subsequent bodies may also be coupled to the first body and the at least one additional body to form a variety of three-dimensional configurations. As a non-limiting example, multiple bodies coupled together may form a variety of polyhedrons including but not limited to triangular pyramids, square pyramids, cubes, rectangular prisms, and any other such configuration capable of being formed by bodies coupled to each other. In such examples of devices including more than one body, additional bodies added to the first body may increase the total amount of surface area treated with an essential-oil-impregnated substrate. Such additional surface area may allow for more pests to be controlled by being exposed to such an example device.

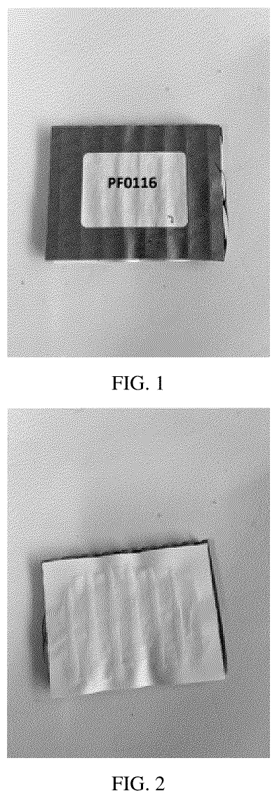

Devices disclosed herein include at least one surface of a device body that has been treated with one or more essential-oil-impregnated substrates. Treatment includes but is not limited to brushing, applying, soaking, or the like a composition disclosed herein onto or into a material. Optionally, at least one additional layer, such as a layer of paper, cloth, wood, plastic, metal, or the like, can then be applied to the at least one treated surface, as shown in FIG. 2. The addition of at least one extra layer can protect the essential-oil-impregnated substrate such that only pests can access it. An extra layer may also keep the substrate from drying out or becoming otherwise degraded. Degradation of a substrate may ultimately decrease its ability to attract pests.

In example aspects, multiple substrates may be applied to devices disclosed herein. As a non-limiting example, a device including multiple surfaces and layers formed between said surfaces may use multiple substrates. In such an example, a first substrate impregnated with a first blend of one or more essential oils and additional components described herein may be applied to a first layer of a device. In such an example, a first layer may be a layer formed between the first surface and opposing surface of the body of the device (e.g., in the corrugated section of a corrugated material). In an additional example, a first layer may be a layer formed between a substrate-treated surface of the body of the device and an additional layer (e.g., paper) applied on top of the substrate-treated surface of the body of the device. In such examples, a second substrate impregnated with a second blend of one or more essential oils and additional components described herein may then be applied to a second layer of a device.

As a non-limiting example, a second layer could be formed by adding an additional layer of paper on top of the previous layer of paper. In such an example, the second substrate would be applied to the top of the first layer of paper. A second layer of paper would then be applied to the top of the second substrate. In an additional, non-limiting example, an additional layer of cardboard or any other such material could be layered onto the first layer. In all such examples, substrates and layers of materials may continue being applied to create a wide variety of possible numbers of layers and substrate compositions retained within a device. Such combinations may allow for many different pests to be controlled by a singular device. Additionally, in devices containing multiple bodies, as described above, each body could be layered as such. Each body, without having been layered as such, could additionally be treated with unique substrate compositions. As such, each body in a multiple-body device could control different groups of pests.

In an aspect, the compositions disclosed herein may be used as insecticides, repellents, and parasiticides for pests, as described herein.

In aspects of the invention, the choice of components to be included in an example composition is dependent on the application and its accompanying factors. Such factors may include, but are not limited to, species of pest to be controlled, quantity of pests to be controlled, location of the pests, and other such factors. In more extreme applications, a composition using a higher concentration of active ingredients (e.g. essential oils, etc.) may be used. Such applications include, as a non-limiting example, applications addressing pests that have developed a resistance or tolerance to the essential oils being used.

### III. Methods of Use of Essential Oil Impregnated Devices

The present disclosure relates to methods of use of devices disclosed herein. Devices can be created by treating at least one surface of a body of a device with an essential-oil-impregnated substrate. Additional layers may be added to such a device, and any of these steps can be repeated in order to create a number of devices described herein. A resulting device can be placed in a variety of locations. A device can be placed anywhere where pests are known to reside to control a number populations of said pests. Pests will eat the substrate (e.g., a natural glue), causing the pest to die due to the biocidal effects of the one or more essential oils or blends thereof. Such pests may also bring the substrate back to a den or central location where additional pests will also consume the substrate. In such an example, a pest may either bring the substrate back inadvertently due to the substrate sticking to the pest (e.g., “tracking” the substrate into the den) or bring the substrate back intentionally to provide it to other pests as a food source. In such examples, other pests may also eat the substrate, killing or otherwise controlling more pests than the original consumer. In such examples, a substrate retrieved to a den may also aid in controlling eggs. Eggs may be located in a den and exposed to compositions disclosed herein, thus killing the eggs when the substrate is brought back to the den. Pests may also be controlled by contacting the essential oil impregnated substrate.

The present disclosure relates to methods of controlling one or more pests, as described herein. Such methods include providing devices as disclosed herein and placing the devices in locations in need of treatment. As non-limiting examples, locations include homes, apartment buildings, bakeries, beverage plants, bottling facilities, breweries, cafeterias, candy plants, canneries, cereal processing and manufacturing plants, dairy barns, poultry facilities, stock yards, flour mills, food processing plants, frozen food plants, homes, hospitals, hotels, houses, industrial buildings, kennels, kitchens, laboratories, manufacturing facilities, mausoleums, meat processing and packaging plants, meat and vegetable canneries, motels, nursing homes, office buildings, restaurants, schools, stores, supermarkets, warehouses and similar structures, building foundations, dairy facilities, drive-in restaurants, drive-in theaters, golf courses, parks, playgrounds, poultry houses, recreational areas, schools, urban areas, lawns, landscape areas, trees, turf, areas around bodies of water, zoos, and other such locations. One or more devices may be placed in such locations. It may be advantageous to place the devices in places in a location that are known to receive higher pest traffic. This may cause more pests to contact the device and thus increase pest control. A larger number of devices may also be placed in a location that is known to have a more severe pest problem. As a result, the extra devices will help to address the problem's severity by contacting more pests.

In an aspect of the invention, the compositions as described above may be more effective at controlling pests based on a substrate chosen, a type of location targeted, and other such factors. Pests to be controlled include but are not limited to arthropods (e.g., insects, arachnids, and other such arthropods), external parasites, and a variety of other pests known in the art and further described herein.

As previously described, compositions described herein are not toxic to humans and other animals. This can be attributed to the functionality of the compositions described herein. The compositions of the current invention first dissolve the exoskeleton of a target pest before then targeting hormone receptors present in the pest to effectively repel, kill, control, and/or resist the pest. Compositions also may act by binding to biochemical receptors in the pest. The biochemical receptors targeted by the compositions are not present in humans or other animals, or are present in a lesser extent or different form than in pests targeted by the compositions disclosed herein. This effect decreases the toxicity of the current invention in view of pesticides currently on the market.

In addition to compositions disclosed herein including only an essential oil as an active component, essential oil compositions disclosed herein may be combined with synthetic pesticides if necessary. In such an aspect, the amount of synthetic pesticide required to control pests would be reduced due to its combination with one or more essential oils or combinations thereof. This represents an added use of compositions disclosed herein. Such use may not completely eliminate the toxicity of a pesticide to a human but may decrease its potency. A higher concentration of essential oil used in combination with a traditional pesticide will present a lower human toxicity. In such examples, the addition of non-toxic, essential oil compositions disclosed herein may reduce the amount of potentially toxic synthetic pesticide to be used. This provides significant health advantages to those wanting to still use a synthetic pesticide while reducing the level of exposure and/or toxicity. Non-limiting examples of such synthetic pesticides include but are not limited to pyrethrins (which include cinerin I, cinerin II, jasmolin I, jasmolin II, pyrethrin I, pyrethrin II and mixtures thereof) and pyrethroids, carbamates (which include but are not limited to benomyl, carbanolate, carbaryl, carbofuran, meththiocarb, metolcarb, promacyl, propoxur, aldicarb, butocarboxim, oxamyl, thiocarboxime and thiofanox), and any combinations thereof.

### IV. Pests to be Controlled

In an aspect, compositions of the present disclosure are used to control one or more pests. In such aspects, pests may include but are not limited to arthropods (e.g., insects, arachnids, and other such arthropods), external parasites, and a variety of other pests known in the art that may infiltrate indoor spaces. Non-limiting examples of pests that can be controlled through devices and methods disclosed herein are provided below. The below lists are to be understood by one of skill in the art to not be all inclusive. Instead, one of skill in the art will appreciate the wide variety of pests that could be controlled and that the following merely provides a non-limiting set of examples.

i. Example Arthropods, Myriapods, Arachnids, External Parasites, and Other Pests.

In an aspect, devices and methods of the present disclosure are used to control one or more arthropods, and a variety of other pests known in the art infiltrating indoor spaces. Arthropods include any insects (e.g., silverfish, flies, fleas, ticks, and the like), myriapods (e.g., centipedes, millipedes, and the like), arachnids (e.g., spiders, mites, scorpions, and the like), and crustaceans (e.g. slaters, crabs, and the like). Lists of example pests, as described above, are provided below. One of skill in the art will appreciate the wide variety of arthropods, and other pests and understand that the following lists serve merely as examples.

From the order of the Siphonaptera, for example, Ctenocephalides felis, Ctenocephalides canis, Pulex irritans, Spilopsyllus cuniculi, Tunga penetrans, and Xenopsylla cheopis.

From the order of the Zygentoma, for example, Lepisma saccharinum or Thermobia domestica.

From the order of the Acari, for example, Rhipicephalus sanguineus, Ixodes pacificus, Ixodes scapularis, Amblyomma americanum, Amblyomma maculatum, Dermatocentor andersoni, Dermatocentor variabilis, Haemaphysalis chordeilis, and Boophilus annulatus. From the order of the Isopoda, for example, Oniscus asellus, Armadillidium vulgare and Porecellio scaber. From the order of the Diplopoda, for example, Blaniulus guttulatus. From the order of the Chilopoda, for example, Geophilus carpophagus and Scutigera spec. From the order of the Thysanura, for example, Lepisma saccharina and Thermobia domestica. From the order of the Collembola, for example, Onychiurus armatus. From the order of the Orthoptera, for example, Scapteriscus spp. such as Scapteriscus abbreviatus, Scapteriscus acletus, Scapteriscus borellii, Scapteriscus didactylus, and Scapteriscus vicinus, Neocurtilla hexadactyla, Blatta orientalis, Periplaneta americana, Leucophaea maderae, Blattella germanica, Acheta domesticus, Gryllotalpa spp., Locusta migratoria migratorioides, Melanoplus differentialis and Schistocerca gregaria. From the order of the Dermaptera, for example, Forficula auricularia. From the order of the Isoptera, for example Reticulitermes spp. From the order of the Mallophaga, for example, Trichodectes spp. and Damalinea spp. From the order of the Thysanoptera, for example, Hercinothrips femoralis and Thrips tabaci. From the order of the Heteroptera, for example, Eurygaster spp., Dysdercus intermedius, Piesma quadrata, Cimex lectularius, Rhodnius prolixus and Triatoma spp. From the order of the Homoptera, for example, Aleurodes brassicae, Bemisia tabaci, Trialeurodes vaporariorum, Aphis gossypii, Brevicoryne brassicae, Cryptomyzus ribis, Aphis fabae, Doralis pomi, Eriosoma lanigerum, Hyalopterus arundinis, Macrosiphum avenae, Myzus spp., Phorodon humuli, Rhopalosiphum padi, Empoasca spp., Euscelis bilobatus, Nephotettix cincticeps, Lecanium corni, Saissetia oleae, Laodelphax striatellus, Nilaparvata lugens, Aonidiella aurantii, Aspidiotus hederae, Pseudococcus spp. and Psylla spp. From the order of the Lepidoptera, for example, Pectinophora gossypiella, Bupalus piniarius, Cheimatobia brumata, Lithocolletis blancardella, Hyponomeuta padella, Plutella maculipennis, malacosoma neustria, Euproctis chrysorrhoea, Lymantria spp., Bucculatrix thurberiella, Phyllocnistis citrella, Agrotis spp., Spodoptera exigua, Mamestra brassicae, Panolis flammea, Prodenia litura, Spodoptera spp., Trichoplusiani, Carpocapsa pomonella, Pieris spp., Chilo spp., Pyrausta nubilalis, Ephestia kuehniella, Galleria mellonella, Tineola bisselliella, Tinea pellionella, Hofmannophila pseudospretella, Cacoecia podana, Capua reticulana, Choristoneura fumiferana, Clysia ambiguella, Homona magnanima and Tortrix viridana. From the order of the Coleoptera, for example, Anobium punctatum, Rhizopertha dominica, Acanthoscelides obtectus, Acanthoscelides obtectus, Hylotrupes bajulus, Agelastica alni, Leptinotarsa decemlineata, Phaedon cochleariae, Diabrotica spp., Psylliodes chrysocephala, Epilachna varivestis, Atomaria spp., Oryzaephilus surinamensis, Anthonomus pp., Sitophilus spp., Otiorrhynchus sulcatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon solstitialis and Costelytra zealandica. From the order of the Hymenoptera, for example, Diprion spp., Hoplocampa spp., Lasius spp., Monomorium pharaonis and Vespa spp. From the order of the Diptera, for example, Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tanaus spp., Tannia spp., Bibio hortulanus, Oscinellafrit, Phorbia spp., Pegomyia hyoscyami, Ceratitis capitata, Dacus oleae and Tipula paludosa.

The present disclosure is related to methods and devices for the control of arthropod, external parasites, and other pests at a location, which comprises the treatment of the location (e.g., by devices and methods disclosed herein). Devices and methods described herein may be used at indoor locations and in the maintenance of public health against pests including but not limited to arthropods or other parasites which are parasitic externally upon vertebrates, for example man and domestic animals (e.g., cattle, sheep, goats, equines, swine, poultry, dogs, cats and fishes). Such example pests include, but are not limited to, Acarina, including ticks (e.g. Ixodes spp., Boophilus spp., Boophilus microplus, Amblyomma spp., Hyalomma spp., Rhipicephalus spp. (e.g. Rhipicephalus appendiculatus), Haemaphysalis spp., Dermacentor spp., Ornithodorus spp. (e.g. Ornithodorus moubata)) and mites (e.g. Damalinia spp., Dermahyssus gallinae, Sarcoptes spp. e.g. Sarcoptes scabiei, Psoroptes spp., Chorioptes spp., Demodex spp., Eutrombicula spp.,); Diptera (e.g. Aedes spp., Anopheles spp., Musca spp., Hypoderma spp., Gasterophilus spp., Simulium spp.); Hemiptera (e.g. Triatoma spp.); Phthiraptera (e.g. Damalinia spp., Linognathus spp.); Siphonaptera (e.g. Ctenocephalides spp.); Dictyoptera (e.g. Periplaneta spp., Blatella spp.); Hymenoptera (e.g. Monomorium pharaonis).

Such example pests further include, but are not limited to, arthropods that may damage stored products, such as cereals, including grain and flour, groundnuts, animal feedstuffs, timber and household goods (e.g. carpets and textiles), and the like. Such arthropods include, but are not limited to, beetles, including weevils, moths and mites, such as Ephestia spp. (flour moths), Anthrenus spp. (carpet beetles), Tribolium spp. (flour beetles), Sitophilus spp. (grain weevils) and Acarus spp. (mites).

Additional arthropods include cockroaches, ants and termites and similar arthropod pests that may infest domestic and industrial premises and mosquitoes in various life stages, such as larvae in waterways, wells, reservoirs or other running or standing water. The methods and devices disclosed herein may also be used for the treatment of foundations and structure in the prevention of the attack on buildings by termites, such as Reticulitermes spp., Heterotermes spp., Coptotermes spp.

The methods and devices disclosed herein may also be used against adults, larvae and eggs of Lepidoptera (butterflies and moths), e.g. Heliothis spp. such as Heliothis virescens (tobacco budworm), Heliothis armigera and Heliothis zea, Spodoptera spp. such as S. exempta, S. littoralis (Egyptian cotton worm), S. eridania (southern army worm), Mamestra configurata (bertha army worm); Earias spp. e.g. E. insulana (Egyptian bollworm), Pectinophora spp. e.g. Pectinophora gossypiella (pink bollworm), Ostrinia spp. such as O. nubilalis (European cornborer), Trichoplusia ni (cabbage looper), Pieris spp. (cabbage worms), Laphygma spp. (army worms), Agrotis and Amathes spp. (cutworms), Wiseana spp. (porina moth), Chilo spp. (rice stem borer), Tryporyza spp. and Diatraea spp. (sugar cane borers and rice borers), Sparganothis pilleriana (grape berry moth), Cydia pomonella (codling moth), Archips spp. (fruit tree tortrix moths), Plutella xylostella (diamond back moth); against adult and larvae of Coleoptera (beetles) e.g. Hypothenemus hampei (coffee berry borer), Hylesinus spp. (bark beetles), Anthonomus grandis (cotton boll weevil), Acalymma spp. (cucumber beetles), Lema spp., Psylliodes spp., Leptinotarsa decemlineata (Colorado potato beetle), Diabrotica spp. (corn rootworms), Gonocephalum spp. (false wire worms), Agriotes spp. (wireworms), Dermolepida and Heteronychus spp. (white grubs), Phaedon cochleariae (mustard beetle), Lissorhoptrus oryzophilus (rice water weevil), Meligethes spp. (pollen beetles), Ceutorhynchus spp., Rhynchophorus and Cosmopolites spp. (root weevils); against Hemiptera e.g. Psylla spp., Bemisia spp., Trialeurodes spp., Aphis spp., Myzus spp., Megoura viciae, Phylloxera spp., Adelges spp., Phorodon humuli (hop damson aphid), Aeneolamia spp., Nephotettix spp. (rice leaf hoppers), Empoasca spp., Nilaparvata spp., Perkinsiella spp., Pyrilla spp., Aonidiella spp. (red scales), Coccus spp., Pseudococcus spp., Helopeltis spp. (mosquito bugs), Lygus spp., Dysdercus spp., Oxycarenus spp., Nezara spp.; Hymenoptera e.g. Athalia spp. and Cephus spp. (saw flies), Atta spp. (leaf cutting ants); Diptera e.g. Hylemyia spp. (root flies), Atherigona spp. and Chlorops spp. (shoot flies), Phytomyza spp. (leaf miners), Ceratitis spp. (fruit flies); Thysanoptera such as Thrips tabaci; Orthoptera such as Locusta and Schistocerca spp. (locusts) and crickets e.g. Gryllus spp. and Acheta spp.; Collembola e.g. Sminthurus spp. and Onychiurus spp. (springtails), Isoptera e.g. Odontotermes spp. (termites), Dermaptera e.g. Forficula spp. (earwigs) and also other arthropods of agricultural significance such as Acari (mites) e.g. Tetranychus spp., Panonychus spp. and Bryobia spp. (spider mites), Eriophyes spp. (gall mites), Polyphagotarsonemus spp.; Blaniulus spp. (millipedes), Scutigerella spp. (symphilids), Oniscus spp. (woodlice) and Triops spp. (crustacea).

Additional arthropod pests to be treated by one or more methods and devices described herein include the following. From the order of the Isopoda, for example, Oniscus asellus, Armadillidium vulgare and Porcellio scaber. From the order of the Diplopoda, for example, Blaniulus guttulatus. From the order of the Chilopoda, for example, Geophilus carpophagus and Scutigera spec. From the order of the Symphyla, for example, Scutigerella immaculata. From the order of the Thysanura, for example, Lepisma saccharina or Thermobia domestica. From the order of the Collembola, for example, Onychiurus armatus. From the order of the Orthoptera, for example, Blatta orientalis, Periplaneta americana, Leucophaea maderae, Blattella germanica, Acheta domesticus, Gryllotalpa spp., Locusta migratoria migratorioides, Melanoplus differentialis and Schistocerca gregaria. From the order of the Dermaptera, for example Forficula auricularia. From the order of the Isoptera, for example, Reticulitermes spp. From the order of the Anoplura, for example, Phylloxera vastatrix, Pemphigus spp., Pediculus humanus corporis, Haematopinus spp. and Linognathus spp. From the order of the Mallophaga, for example, Trichodectes spp. and Damalinea spp. From the order of the Thysanoptera, for example, Hercinothrips femoralis and Thrips tabaci. From the order of the Heteroptera, for example, Eurygaster spp., Dysdercus intermedius, Piesma quadrata, Cimex lectularius, Rhodnius prolixus and Triatoma spp. From the order of the Homoptera, for example, Aleurodes brassicae, Bemisia tabaci, Trialeurodes vaporariorum, Aphis gossypii, Brevicoryne brassicae, Cryptomyzus ribis, Doralis fabae, Doralis pomi, Eriosoma lanigerum, Hyalopterus arundinus, Macrosiphum avenae, Myzus spp., Phorodon humuli, Rhopalosiphum padi, Empoasca spp., Euscelis bilobatus, Nephotettix cincticeps, Lecanium corni, Saissetia oleae, Laodelphax striatellus, Nilaparvata lugens, Aonidiella aurantii, Aspidiotus hederae, Pseudococcus spp. and Psylla spp. From the order of the Lepidoptera, for example, Pectinophora gossypiella, Bupalus piniarius, Cheimatobia brumata, Lithocolletis blancardella, Hyponomeuta padella, Plutella maculipennis, Malacosoma neustria, Euproctis chrysorrhoea, Lymantria spp. Bucculatrix thurberiella, Phyllocnistis citrella, Agrotis spp., Euxoa spp., Feltia spp., Earias insulana, Heliothis spp., Laphygma exigua, Mamestra brassicae, Panolis flammea, Prodenia litura, Spodoptera spp., Trichoplusia ni, Carpocapsa pomonella, Pieris spp., Chilo spp., Pyrausta nubilalis, Ephestia kuehniella, Galleria mellonella, Tineola bisselliella, Tinea pellionella, Hofmannophila pseudospretella, Cacoecia podana, Capua reticulana, Choristoneura fumiferana, Clysia ambiguella, Homona magnanima and Tortrix viridana. From the order of the Coleoptera, for example, Anobium punctatum, Rhizopertha dominica, Bruchidius obtectus, Acanthoscelides obtectus, Hylotrupes bajulus, Agelastica alni, Leptinotarsa decemlineata, Phaedon cochleariae, Diabrotica spp., Psylliodes chrysocephala, Epilachna varivestis, Atomaria spp., Oryzaephilus surinamensis, Anthonomus spp., Sitophilus spp., Otiorrhynchus sulcatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon solstitialis and Costelytra zealandica. From the order of the Hymenoptera, for example, Diprion spp., Hoplocampa spp., Lasium spp., Monomorium pharaonis and Vespa spp. From the order of the Diptera, for example, Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae and Tipula paludosa. From the order of the Siphonaptera, for example, Xenopsylla cheopis and Ceratophyllus spp. From the order of the Arachnida, for example, Scorpio maurus and Latrodectus mactans.

As previously discussed, the above examples of pests are non-limiting. The methods and devices disclosed herein are effective in controlling a large variety of pests known in the art. The above is merely provided to partially illuminate the large variety.

### V. Locations to be Administered Compositions

The present disclosure relates to methods of use of devices disclosed herein to treat indoor locations. Such locations may include premises inhabited or used by people, crops, or animals. These include homes, apartment buildings, bakeries, beverage plants, bottling facilities, breweries, cafeterias, candy plants, canneries, cereal processing and manufacturing plants, dairy barns, poultry facilities, stock yards, flour mills, food processing plants, frozen food plants, homes, hospitals, hotels, houses, industrial buildings, kennels, kitchens, laboratories, manufacturing facilities, mausoleums, meat processing and packaging plants, meat and vegetable canneries, motels, nursing homes, office buildings, restaurants, schools, stores, supermarkets, warehouses and similar structures, building foundations, dairy facilities, drive-in restaurants, drive-in theaters, golf courses, parks, playgrounds, poultry houses, recreational areas, schools, urban areas, lawns, landscape areas, trees, turf, areas around bodies of water, and zoos.

### EXAMPLES

### Example 1

About 60 grams of wheat flour was combined with around 90 grams of water and mixed to make a paste. About an additional 210 grams of water were then added to the paste. The mixture was stirred until all lumps were gone. The stirred mixture was then heated on a hot plate set at about 1000 using a magnetic stir rod where the mixture thickened and bubbled at 70° C. The mixture was then removed and cooled to form a glue.

The glue cooled to around room temperature (i.e. about 20° C.) before being combined with an essential oil. About 100 grams of the glue mixture was combined with about 1 grams of essential oil. Four mixtures were made where the essential oil was geraniol, thyme oil, clove oil, or eugenol in the same ratios. All mixtures were stirred to create homogenous mixtures.

Separate rectangles measuring about 70 mm by about 55 mm were cut out of single-sided corrugated cardboard (U-Line Corrugated Wrap Roll A-Flute, part #S-2715) and heavy-stock paper (44-lb, Epson Premium Presentation Paper MATTE, part #S041257). About 1 gram to 1.6 grams of a glue-essential-oil mixture was uniformly spread on one side of the heavy-stock paper. The glued paper was then applied to a side of the corrugated cardboard. This combination was then placed under a weight (about 100 grams) for about 5 to about 10 minutes to allow the glue to adhere the paper and cardboard together. The weight was then removed, and the device was allowed to dry for about 48 hours at room temperature (i.e. about 20° C.). During this time, the mass of glue decreased about 82%, dropping down to about 0.17 to about 0.27 grams.

Separate devices (one impregnated with geraniol (device 1), another with thyme oil (device 2) and a third with eugenol (device 3)) were tested for efficacy against silverfish by placing each device into a plastic box, with 5 replicate boxes for each example. 10 Silver fish (Lepisma saccarina) were placed into the box with the trap and kept under controlled conditions (temperature, humidity, and light), and the mortality of the silverfish recorded at 1 day, 3 days, 6 days, and 8 days post-administration and compared to untreated controls. Results are shown in Table 1.

TABLE 1
Mortality Rates of Silverfish

| | Initial | | | | |
|---|---|---|---|---|---|
| | Silverfish | RATES of MORTALITY | | | |
| | Population | D + 01 | D + 03 | D + 06 | D + 08 |
| Control (untreated | 50 | 0% | 0% | 0% | 0% |
| cardboard) | | | | | |
| Positive control | 50 | 0% | 0% | 8% | 10% |
| Device 1 (Geraniol) | 53 | 4% | 8% | 36% | 60% |
| Device 2 (Thyme Oil) | 50 | 0% | 8% | 30% | 40% |
| Device 3 (Eugenol) | 51 | 4% | 29% | 90% | 100% |

Example aspects of the disclosure can further be described by the following, numbered paragraphs:

An essential-oil impregnated device for controlling pests, the device comprising:
one or more essential oils or blends thereof for controlling pests;
a substrate to attract pests;
a body of the device, wherein the body comprises at least a first and a second surface; and
an additional layer coupled to at least the first or the second surface of the body.

The essential-oil impregnated device of claim 1, wherein the one or more essential oils or blends thereof are selected from a list consisting of clove oil, geraniol, thyme oil, and eugenol.

The essential-oil impregnated device of claim 1, wherein the substrate comprises a glue, bait, food, sugar, or chemical attractant.

The essential-oil impregnated device of claim 3, wherein the substrate comprises a natural-based glue is formed by combining flour and water.

The essential-oil impregnated device of claim 4, wherein the natural-based glue comprises about 60 grams of flour and about 300 grams of water.

The essential-oil impregnated device of claim 1, wherein the one or more essential oils or blends thereof are combined with the substrate to create an essential-oil impregnated substrate.

The essential-oil impregnated device of claim 6, wherein the essential-oil impregnated substrate is applied to a surface of the body of the device.

The essential-oil impregnated device of claim 7, wherein the additional layer is coupled to the surface of the body having received the essential-oil impregnated substrate.

The essential-oil impregnated device of claim 1, wherein the body comprises a material selected from cardboard, corrugated cardboard, plastic, and metal.

The essential-oil impregnated device of claim 1, wherein the additional layer is a paper-based layer.

The essential-oil impregnated device of claim 1, wherein pests comprise silverfish.

The essential-oil impregnated device of claim 1, wherein controlling pests comprises killing, repelling, inhibiting, suppressing, or repressing populations of pests.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

All references cited herein are incorporated by reference in their entirety. The present invention may be embodied in other specific forms without departing from the spirit or essential attributes thereof and, accordingly, reference should be made to the appended claims, rather than to the foregoing specification, as indicating the scope of the invention.

We claim:

1. An essential-oil impregnated device for controlling pests, the device comprising:
a. one or more essential oils or blends thereof for controlling pests;
b. a substrate to attract pests, wherein the one or more essential oils or blends thereof are combined with the substrate; and
c. a body of the device, wherein the body comprises at least a first and a second surface.

2. The essential-oil impregnated device of claim 1 further comprising an additional layer coupled to at least the first or the second surface of the body.

3. The essential-oil impregnated device of claim 1, wherein the one or more essential oils or blends thereof are selected from a list consisting of clove oil, geraniol, thyme oil, and eugeneol.

4. The essential-oil impregnated device of claim 1, wherein the one or more essential oils or blends thereof are selected from a list consisting of geraniol, linalool, carvacrol, para-cymene, alpha-pinene, menthol, eugenol, carvacrol, citronella oil, citronellal, citronellol, cinnamaldehyde, cinnamol, mint oils including cornmint oil and peppermint oil, thyme oil, lemongrass oil, rosemary oil, oregano oil, clove oil, citronella oil, cedar oil, cinnamon oil, wintergreen oil, alpha-terpineol, camphor, carvacrol, delta-cadinene, e-beta-caryophyllene, e-sabinene, limonene, p-cymene-8-ol, cerpinen-4-ol, terpinolene, thymol vic-thymol, cedrol, 1,8-cineol,3-carene,3-octanol,3-octanone, 6-ethyl-3,4-dimethylphenol, alpha-humulene, alpha-phellandrene, alpha-pinene, alpha-terpinene, alpha-thujene, aromadendrene, beta-pinene, beta-terpinene, borneol, bornyl acetate, camphene, carvacrol methyl ether, carvone, R-carvone, caryophyllene oxide, citronellal, citronellol, citronellal, e-beta-ocimene, eugenol, gamma-terpinene, geranyl acetate, isoeugenol, ledene, lemongrass oil, limonene, Linalool, menthol, methyl isoeugenol, methyl salicylate, myrcene, nerol, nootkatone, ocimene, p-cymene, safrol, terpinene-4-ol, terpineol, thymol acetate, Z-beta-ocimene, and Z-linalool oxide.

5. The essential-oil impregnated device of claim 1, wherein the substrate comprises a glue, bait, food, sugar, or chemical attractant.

6. The essential-oil impregnated device of claim 5, wherein the substrate comprises a natural-based glue is formed by combining a flour and water.

7. The essential-oil impregnated device of claim 6, wherein the natural-based glue comprises from 1 part up to 10 parts of water combined with 1 part of a flour.

8. The essential-oil impregnated device of claim 5, wherein the natural-based glue comprises about 60 grams of flour and about 300 grams of water.

9. The essential-oil impregnated device of claim 1, wherein the essential-oil impregnated substrate is applied to a surface of the body of the device.

10. The essential-oil impregnated device of claim 2, wherein the additional layer is coupled to the surface of the body, wherein an essential-oil impregnated substrate has been applied to the surface of the body.

11. The essential-oil impregnated device of claim 1, wherein the body comprises a material selected from cardboard, corrugated cardboard, paper, paper-derived materials, cellulosics, plastics, polymers, and metals.

12. The essential-oil impregnated device of claim 2, wherein the additional layer is a paper-based layer, a cardboard layer, or any cellulosic-based layer.

13. The essential-oil impregnated device of claim 1, wherein pests comprise silverfish.

14. The essential-oil impregnated device of claim 1, wherein controlling pests comprises killing, repelling, inhibiting, suppressing, or repressing populations of pests.

15. The essential-oil impregnated device of claim 1, wherein the one or more essential oils or blends thereof are further combined with one or more compositions selected from emulsifiers, surfactants, lubricants, plasticizers, flow agents, antimicrobials, and any combinations thereof.

16. The essential-oil impregnated device of claim 1, wherein the one or more essential oils or blends thereof are further combined with one or more insect growth regulators (IGRs).

17. The essential-oil impregnated device of claim 1, wherein the device comprises more than one body, and wherein the more than one bodies are capable of being oriented in various configurations.

18. The essential-oil impregnated device of claim 17, wherein the more than one bodies are oriented as to create three-dimensional devices including a shape selected from a group consisting of triangular pyramids, square pyramids, cubes, and rectangular prisms.

19. The essential-oil impregnated device of claim 1 comprising at least a first composition of essential oils or a blend thereof, wherein the first composition is deposited onto a first substrate, and at least a second composition of essential oils or a blend thereof, wherein the second composition is deposited onto a second substrate.

20. The essential-oil impregnated device of claim 19, wherein the first and second compositions of essential oils or blends thereof that have been deposited onto substrates are separated within one or more bodies of the device, and wherein such configuration allows the device to control more than one variety of pest simultaneously.
